(19) United States
(12) Patent Application Publication
(10) Pub. No.: US 2018/0034759 A1
(43) Pub. Date: Feb. 1, 2018

(54) ANALYZING USER MOBILE COMMUNICATION PATTERNS AND APPLYING TO USER INITIATED COMMUNICATIONS

(71) Applicant: INTERNATIONAL BUSINESS MACHINES CORPORATION, ARMONK, NY (US)

(72) Inventors: Siddharth K. Saraya, Raniganj (IN); Alok K. Singh, Bangalore (IN)

(21) Appl. No.: 15/219,358

(22) Filed: Jul. 26, 2016

(51) Int. Cl. H04L 12/58; H04W 4/02; H04W 4/14; H04L 29/12

(52) U.S. Cl. CPC H04L 51/16; H04L 61/1594; H04W 4/028; H04W 4/14

(57) ABSTRACT

A method and system automatically contacts a user's contacts on a mobile device. The method and system includes accessing a contact list on a mobile device for a user, and detecting and saving a communication history for each of a plurality of contacts on a mobile device. In response to the user initiating communication with a contact on the contact list, a communication history is analyzed for the contact by the user. The communication history includes one or more communication techniques for communicating with the contact. A communication protocol is determined for the contact, where the communication protocol including one or more of the communication techniques for communicating with the contact. The method and system iteratively initiates communication to the contact based on the communication protocol using the communication techniques.

### BACKGROUND

The present disclosure relates to a method and system for monitoring user patterns in initiating communications with contacts on the user's device, and using the pattern in initiating communication with one or more user contacts.

A user may use a mobile device have an address book with a plurality of contacts to initiate communication with one or more of the contact in the address book. The contacts may have a multiplicity of contact numbers and modes of communication, such as telephone/cellular numbers, messaging availability, and other modes that may include using the Internet. In another example, the user may have multiple SIM (Subscriber Identification Module) cards. In one example, a user can have a mobile address book which includes contacts with an office phone, home phone, and an alternate number. In another example, a contact can be contacted or communicated with using other communication mediums included in the address book, for example, SMS (Short Message Service) messaging, and Internet based communication mediums or modes.

In one example, a user may attempt to reach a contact having multiple numbers or modes of contact or communication. The user can dial iteratively, one number after another, trying to reach the contact and not connecting, for example, due to lack of cell phone coverage or a lack of network coverage. In a further attempt to reach the contact, a user can try other mediums or modes to establish communication with the contact, including SMS or another communication medium or mode. A users iterative attempts to reach a contact require the user to repeatedly initiate contacting the selected contact, for example, inquiring regarding an additional telephone number or a different mode or method of communication. The user may have to manually search their address book and manually implement initiating contact with the selected contact. The above process for iteratively establishing communication with one or more contacts can be undesirable, for example, at least because the process can be tedious, time consuming, and inefficient for the user.

### SUMMARY

In one example, it would be beneficial for a method and system to monitor and analyze a user communication behavior regarding reaching contacts using their mobile device. The communication pattern can be analyzed to detect a pattern in contacting a contact on a contact/address list of a mobile device for the user, and applied to automatically initiate communications to a selected contact by the user.

According to an aspect of the present invention, a method automatically contacts a user's contacts on a mobile device. The method detects and saves a communication history for each of a plurality of contacts on a mobile device. The communication history is analyzed for a contact of the plurality of contacts on the mobile device, in response to a user initiating communication with the contact. The method detects one or more communication techniques for communicating with the contact as part of the communication history. A communication protocol is determined for the contact, and the communication protocol includes one or more of the communication techniques for communicating with the contact. The method iteratively initiates communication to the contact based on the communication protocol using the communication techniques.

In another aspect according to the invention, a system automatically contacts a user's contact on a mobile device. The system comprises: a computer system comprising: a computer processor, a computer-readable storage medium, and program instructions stored on the computer-readable storage medium being executable by the processor, to cause the computer system to perform a method, comprising: detecting and saving a communication history for each of a plurality of contacts on a mobile device; analyzing the communication history for a contact of the plurality of contacts on the mobile device, in response to a user initiating communication with the contact; detecting one or more communication techniques for communicating with the contact as part of the communication history; determining a communication protocol for the contact, the communication protocol including one or more of the communication techniques for communicating with the contact; and iteratively initiating communication to the contact based on the communication protocol using the communication techniques.

In another aspect according to the invention, a computer program product automatically contacts a user's contacts on a mobile device. The computer program product comprises a computer readable storage medium having program instructions embodied therewith, wherein the computer readable storage medium is not a transitory signal per se, and the program instructions executable by a computer to cause the computer to perform a method, comprising: detecting and saving a communication history for each of a plurality of contacts on a mobile device; analyzing the communication history for a contact of the plurality of contacts on the mobile device, in response to a user initiating communication with the contact; detecting one or more communication techniques for communicating with the contact as part of the communication history; determining a communication protocol for the contact, the communication protocol including one or more of the communication techniques for communicating with the contact; and iteratively initiating communication to the contact based on the communication protocol using the communication techniques.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawing are discussed forthwith below.

FIG. 1 is a schematic block diagram illustrating an overview of a system and methodology for automatically contacting a user's contacts on a mobile device.

FIG. 2 is a flow chart illustrating a method for automatically contacting a user's contacts on a mobile device based on the system shown in FIG. 1, according to an embodiment of the disclosure.

FIG. 3 is a functional block diagram of an example system and method according to an embodiment of the present invention, and in accordance with the system and method shown in FIGS. 1 and 2.

FIG. 4 is a schematic block diagram depicting a computer system according to an embodiment of the disclosure which includes a computer shown in FIG. 1, and cooperates with the system and method shown in FIGS. 1, 2, and 3.

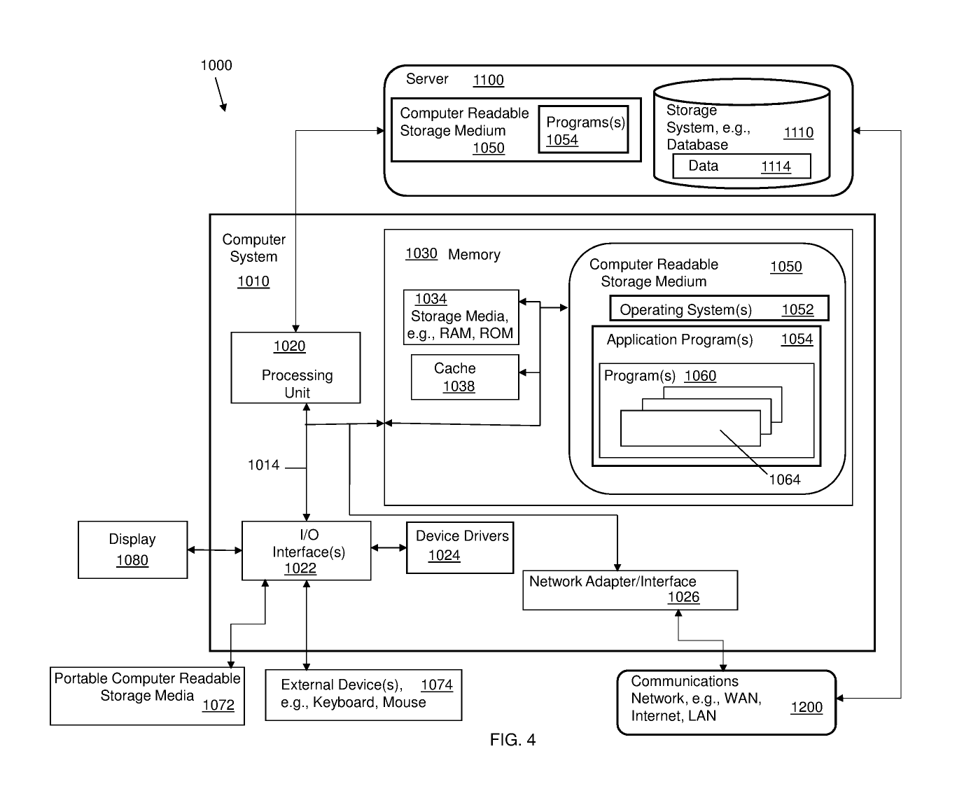

### DETAILED DESCRIPTION

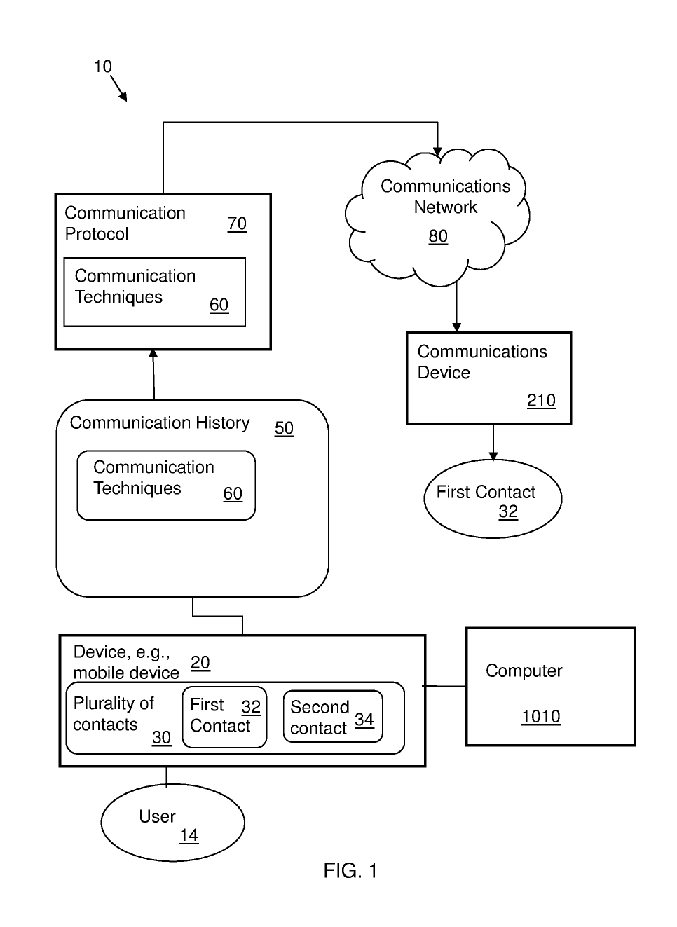

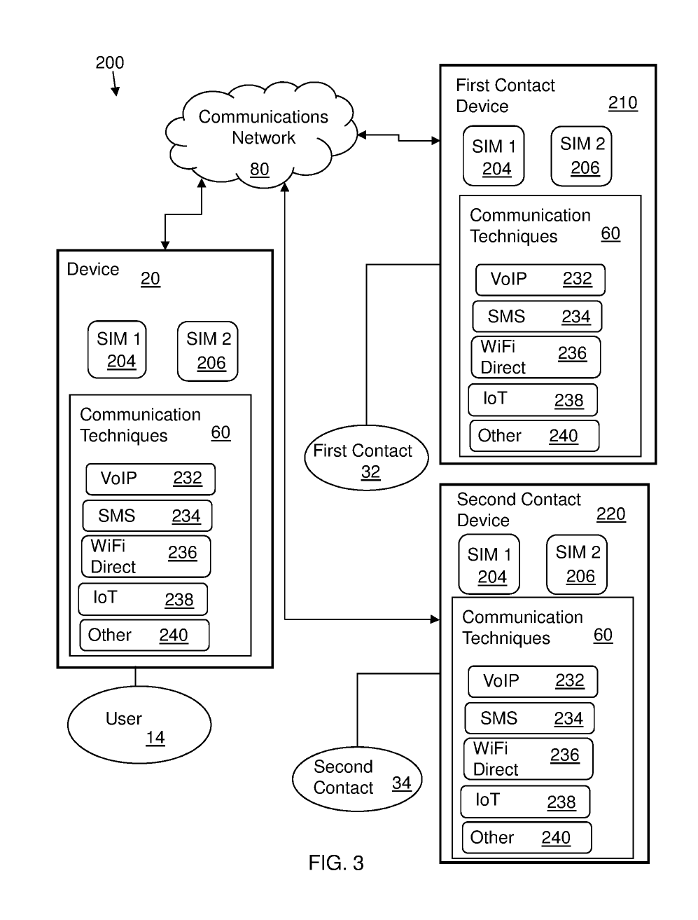

Referring to FIGS. 1, 2, and 3, an embodiment according to the present invention includes a system 10 and method 100 for automatically contacting a user's contacts on a mobile device. A user 14 has a device embodied as a mobile device 20 (which is referred to herein as a device or a mobile device). The device is understood to represent a multiplicity of communications devices of mobile devices, including, but not limited to, a cell phone, a smart phone, or other mobile device used for communicating with contacts stored in the device. The device 20 includes a contact list (or an address book) including a plurality of contacts. The contact list and one or more of the contacts are referred to herein as a contact, contacts, or plurality of contacts 30. The contacts or contact list 30 can be part of an application (software application), for example part of a contact application, or a telephone list of contacts, or an address book stored on the device, and used when initiating communication (e.g., telephoning or messaging) a contact. The device 20 includes a computer 1010, which is discussed in more detail with reference to FIG. 3 in relation to a computer system 1000. It is understood that the device 20 and the computer 1010 are representative or illustrative of many alternative computer devices and are presented here as generic representations for the purposes of the embodiment of the present invention. In the embodiment discussed below, for illustrative purposes, the method of the present disclosure can be embodied in a computer program 1060 (FIG. 3) or a software application stored on the computer 1010, or stored on another storage device communicating with the device 20. Alternative embodiments can include a computer program stored remotely (for example, on a remote server 1100 (FIG. 3)), and, for example, can be implemented as a service.

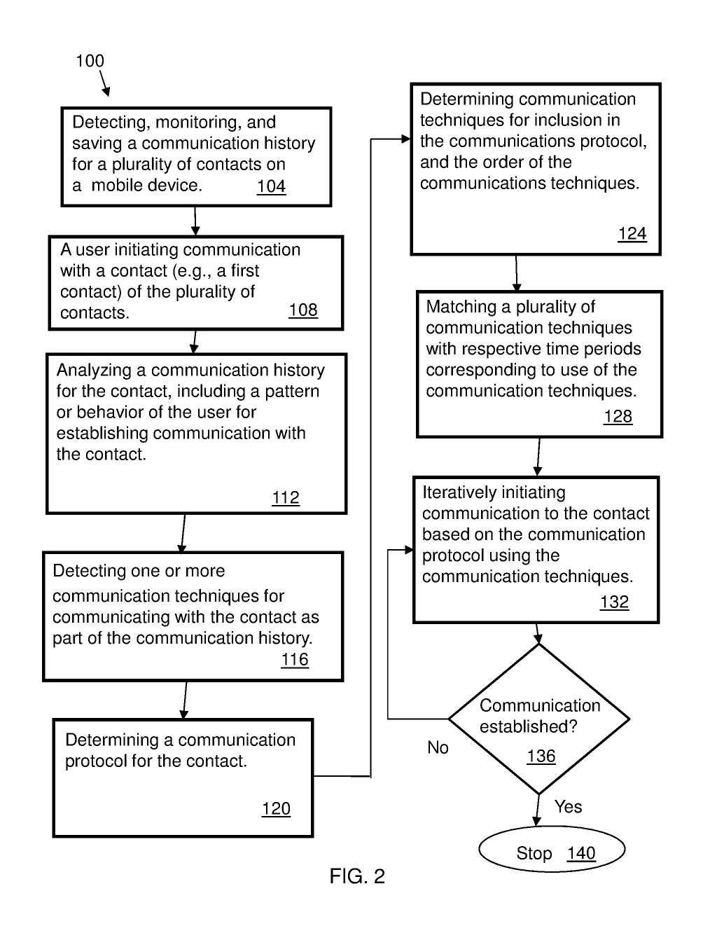

Referring to FIGS. 1 and 2, the method 100 includes detecting, monitoring, and saving a communication history 50 for each of a plurality of contacts 30 on a mobile device 20, as in block 104. For illustrative purposes, as shown in FIG. 1, the plurality of contacts 30 can include a first contact 32, and a second contact 34.

A user initiates communication with a first contact 32 of the plurality of contacts 30, as in block 108. The method 100 includes analyzing the communication history 50 for the first contact 32, as in block 112. Analyzing the communication history 50 includes detecting a pattern or behavior of the user for establishing communication with the contact, and performing the analysis for each of the user's contacts. The communication history can include creating a profile for each of the contacts which incorporates each of the contacts communication history as described above. The analysis of the communication history is dynamic and changes over time, that is, as the communication history changes and pattern of usage change, the communication history is dynamically updated and changed.

The communication history for each of the contacts can include one or more communication techniques (or modes of communication) for communicating with each of the plurality of contacts (that is, establishing contact, or reaching the contact in the contact list or address book). The communication techniques can include, for example, a network, a communications system, a communications type, and multiple telephone numbers, the Internet, as well as, signal strength, signal availability, and a contact's times of availability. The communication network(s) used by the device to reach the contacts are generically represented as a communications network 80 (FIGS. 1 and 3). Additional communication techniques 60 used by the device (shown in FIG. 3 and discussed below) can include Voice over Internet Protocol (VoIP) 232, Short Message Service (SMS) 234, Wi Fi Direct 236 (for enabling devices to connect with each other), a tool or application for connection with the Internet of Things (IoT) 238, and other communication technologies and techniques 240.

As shown in block 116, the method includes detecting one or more communication techniques 60 for communicating with the first contact 32, as part of the communication history.

The method includes determining a communication protocol 70 for the first contact 32, as in block 120, based on the communication history. For example, the method can detect the pattern of use of the user for contacting a contact, (e.g., communication technique, time, sequence of modes of contact), and incorporate the pattern in the communication protocol 70. The communication protocol 70 includes one or more of the communication techniques 60 for communicating with the first contact 32, and determines an order of the communication techniques, as in block 124. For example, the communication techniques are ordered based on their likelihood of reaching the contact. For instance, prioritizing communications techniques based on the communication history. Thus, the communication history for each contact can be analyzed to determine a communication protocol for each of the contacts.

The determination of an order or prioritization of communication techniques can include, network availability, network strength, as well as communications system, and communications type. The method can match one or more of the communication techniques with the communication history to initiate usage of the communication technique. For example, the method includes matching a plurality of communication techniques with respective time periods corresponding to use of the communication techniques, as in block 128.

The method includes iteratively initiating communication to the first contact 32 based on the communication protocol 70 using the communication techniques 60, as in block 132.

The method includes determining when a communication is established, that is, when the first contact 32 is reached (block 136) on the first contact's communication device 210 also referred to as the first contact device (e.g., mobile device), using one of a plurality of communication techniques 60. If the contact has not been reached, the method returns to blocks 132 and the method continues to iteratively initiative communication with the contact. When the contact is reached (communication is established), the method stops (block 140).

More specifically, the communication protocol 70 can be based on one or more factors. The factors can be selected from a group, which includes: network strength, network availability, cost of use of a service, cost of using a data plan, Internet availability, Internet strength, and a cost of using the Internet. For example, the network strength can be considered when developing the communication protocol for a contact.

Additionally, the method can use the communication history, and match each of a plurality of communication techniques with one or more factors relating to use of the communication technique. The factors can be selected from a group including: a time period; a location of the user; a location of a recipient; availability of a network; availability of a communications system; and cost of a service. For example, a telephone number for a contact can be matched with a time period in which the contact was previously reached or connected with.

For example, the method of the present disclosure can detect that a contact of a user is successfully communicated with using a specific communication channel during a time period, and the user fails to contact the same contact using another communication channel during the same time period or during another time period. Thus, the method learns from the communication history of the user in relation to the user's contacts. For example, a contact may be reachable using VoIP at night because Internet usage is available at the user home. Further, the contact may have evenings when they are typically out of the house and cell phone coverage is best for contacting them. The method according to the present disclosure can capture these preferences regarding communication techniques.

Further, the communication techniques can include: telephone services, internet services, and messaging services. In one example, the communication protocol can initiate communications with a contact in the following order: telephone numbers, an internet service, and a messaging service.

In another example, the communication protocol includes using an SMS (Short Message Service) service or an Internet service based on the cost associated with an SMS plan or a data plan.

In one example, in response to the contact having a single communication technique, the single communication technique can be used to communicate with the contact.

In another example according to the embodiments of the present disclosure, the method and system includes detecting and monitoring a communication history for each contact across multiple communication techniques, for example, telephone, cell phone, Internet services, Voice over IP, video conferencing. Further, factors included in creating a communication protocol include a location of the user and a locating of a contact, time of the call which could relate to connectivity and cost of communications, connectivity issues, cost of communication for the user as well as the contact.

Referring to FIG. 3, a system 200 (which expands on the system 10 shown in FIG. 1) includes in one example, according to the embodiments of the present disclosure, the user 14 and their device 20 interacting with a first contact 32 and a second contact 34. The user 14 can initiate contact with the first contact 32 or the second contact 34 using a variety of communication techniques 60 as discussed above. In the example shown in FIG. 3, the user 14 and the first and second contacts 32, 34 can use first and second contact devices, 210, 220, respectively (also referred to as first and second communication devices) (e.g., a mobile device or a smart phone). The first and second contact devices, 210, 220 can have dual or multiple SIMs (or SIM card(s)) (Subscriber Identification Module or Subscriber Identity Module) with their cell phone or mobile device. For exemplary purposes, the devices are shown having a SIM 1 card 204 and a SIM 2 card 206, in each of the first contact's 32 and second contact's 34 communications devices 210, 220 (which can include a cell phone, or other mobile device). The first contact device 210 includes dual SIM cards 204, 206, and the second contact device 220 likewise includes dual SIM cards 204, 206. The user (and the contacts in this example) may each use SIM cards based on a location network strength and/or a subscriber cost of a service plan. Communication techniques 60 which may be used by the device can include Voice over Internet Protocol (VoIP) 232, Short Message Service (SMS) 234, Wi Fi Direct 236 (for enabling devices to connect with each other), a tool or application for connection with the Internet of Things (IoT) 238, and other communication technologies and techniques 240.

Factors which can contribute in deciding which communications technique to use can include, cost, network location, clarity of voice communications, and other variables. Each selection of a communications technique by a user is captured automatically, according to the present disclosure, for future communications with the contact, thus the method and system learns according to the users use history (communications history) 50.

In general, the method and system of the present disclosure can detect a sequence or pattern of a user/caller to identify a calling behavior of the caller and identify and record the caller behavior as a profile is automatically captured by learning from the behavior of the caller and recorded as a dialing profile or communication history. The method and system can include automatic dialing of a contact in a mobile device using multiple networks which can be based on, for example, signal strength at a particular location (or picking the network which has the strongest signal strength). If the contact is not reachable, automatically calling other contact numbers of the same callee, and if no contact is made, automatically calling VOIP (Voice Over IP (Internet Protocol)), or using calling using a service (such as video chat and voice call services using the Internet) to the same callee, and alternatively automatically sending an SMS (Short Message Service) or other text messaging to the callee. Thus, according to the embodiments of the present disclosure, the method and system presented herein traverses (or crosses) different communication technologies, such as cell phone service, Internet based, voice over IP, messaging services, analyzing user behavior, and other factors (such as cost and availability due to location (of the user and the contact)), as embodied in the communication protocol of the present disclosure. The method and system detects communication technologies used by the user, and initiates a communication protocol including initiating communications with a desired or specified contact of the user (as initiated by the user) in a sequence based on a user pattern or behavior and the other factors. Thereby, the method iteratively initiates communication with the selected contact based on a communication protocol as described above. Thus, the present disclosure includes a mechanism of analyzing a user's communication behavior or pattern regarding a contact or specific person, and uses the analyzed behavior to connect to the contact, in response to a user initiating a call to the contact.

Thereby, the present disclosure provides a mechanism to analyze user mobile communicating patterns and behavior regarding the contacts in the user's address book, and uses the analyzed pattern during communication without any user intervention. The analyzed behavior includes user communicating patterns with specific contacts which can also vary based on user geographical location.

One benefit of the present disclosure is that a user can initiate a call or contacting action and establish communication (e.g., the communication protocol) by automatically initiating contact based on a previous analyzed pattern (e.g., communication history). This relieves the user from dialing and/or finding multiple modes of communication (communication techniques) for a contact, and initiating each means of communication, for example, dialing multiple numbers in sequence, then texting, then initiating a video conferencing session, etc.

In one embodiment according to the present disclosure, a user has an address book or contact list of contacts in a mobile device. The contact list is stored with associated numbers. Some of the contacts may have one number, other contacts may have multiple numbers. Some contacts may have multiple numbers and have other communication techniques associated with the contact, for example, messaging (SMS). Contacts with single number are contacted with the one number associated with the contact.

Contacts with multiple number associated to them, typically have the user knowing where to call first, and then if the contact is not reached, the user tries another number or method of contacting the contact which they think, or know from experience, will reach the user. The user behavior can depend on the network availability, subscription plan, costs of establishing communication, for example, cost of placing a call, video conferencing, messaging, or Internet based channels of communication. This behavior or pattern is ascertained by the method and system of the present invention and initiated and implemented by the method 100 and system 10. When using Internet based communications, a user can have multiple internet based channels available, which works only when there is internet connectivity.

Thus, one example of a user initiating contact/communication with a contact can include the following pattern: a user calls a contact on the contact's mobile number, associated with their office; if that number doesn't work, the user dials the contact's home number, and if that does not work, the user dials subsequent other numbers. When none of the above works to establish communication with the contact, the user then initiates SMS service or internet based messaging service, (which can be based on the SMS plan or data plan (e.g., considering the contact's availability or cost based on using these modes of communication (e.g., the SMS or data plan), and can also consider user's availability or cost of the modes of communication).

It is understood that a user's behavior pattern can change due to location (e.g., the users locations as well as the contact's location). For example, based on the location, network strength changes which can decide the user's behavior of using any specific number or any other communication mode.

In one instance, a caller (also referred to herein as a user) can have a dual SIM (or SIM card) (Subscriber Identification Module or Subscriber Identity Module) with their cell phone or mobile device (as described above), and use each of the SIMs based on the location network strength and subscriber cost plan (or service plan). In another example, when a contact authorizes or suggests a particular time for a user to call them is better because of a cost benefit for the contact, the communication technique can be recorded or accepted by the method for future use when initiating contact with the contact, thus being captured in the communication history.

One of the benefits of the embodiments of the present disclosure is the method and system according to the present disclosure eliminates the need for a user to select and initiate calling sequentially, and sequentially initiating other modes of communication. The embodiments of the present disclosure provide a mechanism to analyze a user communication behavior associated with each of a user's contacts, including the contacts presumed location based on past experiences of the user, such that the communication behavior or pattern (communication history) can be incorporated (as factors) in a communication protocol. Changes in behavior based on location of the user can also be analyzed, and embodied in a communication protocol as a factor.

The communication protocol can also define how many times an attempt can be made to reach or contact a contact (in the user's address book) using a communication technique, for example, how many times a call can be tried before moving to a next communication technique. In another example, a predefined messaging template can be used if SMS service or an Internet based communication service plan is used. In another embodiment, a user can manually redefine a behavior pattern (e.g., the communication history) rather than allowing the method and system of the present embodiment automatically detect a change in communication behavior or pattern.

Referring to FIGS. 1 and 3, the device 20 includes a computer system 1010. The device 20 can access a remote server or computer 1100 using a communications network 1200 (e.g., the Internet) (FIG. 3). A computer system 1010 is a generic representation of a computer which may be embodied in a device such as a server for providing the method of the present disclosure as a service which can be accessible using the Internet or a network. The computer system is described in more detail below. The embodiments of the method of the present disclosure can be captured in a software application or program, for example, a program(s) 1060 in the computer 1010. The program 1060 can be a separate application(s), and alternatively can be part of (or integral with) another application. The method can also be provided as a service which can be remote, for instance, including an application residing on a remote server exemplified by the remote server 1100.

Referring to FIG. 3, a system 1000 includes a computer system or computer 1010 shown in the form of a generic computing device. The method 100, for example, may be embodied in a program(s) 1060 (FIG. 3) embodied on a computer readable storage device, for example, generally referred to as memory 1030 and more specifically, computer readable storage medium 1050 as shown in FIG. 3. For example, memory 1030 can include storage media 1034 such as RAM (Random Access Memory) or ROM (Read Only Memory), and cache memory 1038. The program 1060 is executable by the processing unit or processor 1020 of the computer system 1010 (to execute program steps, code, or program code). Additional data storage may also be embodied as a database 1110 which can include data 1114. The computer system 1010 and the program 1060 shown in FIG. 3 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in FIG. 3 as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, as shown in FIG. 3, the system 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media 1034 in the form of volatile memory, such as random access memory (RAM), and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method 100 (FIG. 2), for example, may be embodied in one or more computer programs, generically referred to as a program(s) 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of automatically contacting a user's contacts on a mobile device, comprising:
detecting and saving a communication history for each of a plurality of contacts on a mobile device;
analyzing the communication history for a contact of the plurality of contacts on the mobile device, in response to a user initiating communication with the contact;
detecting one or more communication techniques for communicating with the contact as part of the communication history;
determining a communication protocol for the contact, the communication protocol including one or more of the communication techniques for communicating with the contact; and
iteratively initiating communication to the contact based on the communication protocol using the communication techniques.

2. The method of claim 1, wherein the communication techniques of the communication history for the contact are selected from a group consisting of: a network, network availability, network strength, a communications system, a communications type, and multiple telephone numbers.

3. The method of claim 1, further comprising:
prioritizing communications techniques based on the communication history.

4. The method of claim 1, further comprising:
matching one or more of the communication techniques with the communication history to initiate usage of the communication technique.

5. The method of claim 1, wherein the communication protocol includes matching a plurality of communication techniques with respective time periods corresponding to use of the communication techniques.

6. The method of claim 1, wherein the communication protocol is based on one or more factors selected from a group consisting of: network strength, network availability, cost of use of a service, cost of using a data plan, Internet availability, Internet strength, and a cost of using the Internet.

7. The method of claim 1, further comprising:
using the communication history, matching each of a plurality of communication techniques with one or more factors relating to use of the communication technique, the factors being selected from a group consisting of: a time period; a location of the user; a location of a recipient; availability of a network; availability of a communications system; and cost of a service.

8. The method of claim 1, wherein the communication techniques are selected from a group consisting of: telephone services, internet services, and messaging services.

9. The method of claim 1, wherein the communication protocol includes initiating communications with the contact in the following order: telephone numbers, an internet service, and a messaging service.

10. The method of claim 1, further comprising:
analyzing each contact to determine a communication protocol for each of the contacts.

11. The method of claim 1, further comprising:
in response to the contact having a single communication technique, using the single communication technique to communicate with the contact.

12. The method of claim 1, wherein the communication protocol includes using an SMS service or an Internet service based on the cost associated with an SMS plan or a data plan.

13. A system for automatically contacting a user's contacts on a mobile device, the system comprising:
a computer system comprising: a computer processor, a computer-readable storage medium, and program instructions stored on the computer-readable storage medium being executable by the processor, to cause the computer system to perform a method, comprising:
detecting and saving a communication history for each of a plurality of contacts on a mobile device;
analyzing the communication history for a contact of the plurality of contacts on the mobile device, in response to a user initiating communication with the contact;
detecting one or more communication techniques for communicating with the contact as part of the communication history;
determining a communication protocol for the contact, the communication protocol including one or more of the communication techniques for communicating with the contact; and
iteratively initiating communication to the contact based on the communication protocol using the communication techniques.

14. The system of claim 13, wherein the communication techniques of the communication history for the contact are selected from a group consisting of: a network, network availability, network strength, a communications system, a communications type, and multiple telephone numbers.

15. The system of claim 13, further comprising:
prioritizing communications techniques based on the communication history.

16. The system of claim 13, further comprising:
matching one or more of the communication techniques with the communication history to initiate usage of the communication technique.

17. The system of claim 13, wherein the communication protocol includes matching a plurality of communication techniques with respective time periods corresponding to use of the communication techniques.

18. The system of claim 13, wherein the communication protocol is based on one or more factors selected from a group consisting of: network strength, network availability, cost of use of a service, cost of using a data plan, Internet availability, Internet strength, and a cost of using the Internet.

19. The system of claim 13, further comprising:
using the communication history, matching each of a plurality of communication techniques with one or more factors relating to use of the communication technique, the factors being selected from a group consisting of: a time period; a location of the user; a location of a recipient; availability of a network; availability of a communications system; and cost of a service.

20. A computer program product for automatically contacting a user's contacts on a mobile device, the computer program product comprising a computer readable storage medium having program instructions embodied therewith, wherein the computer readable storage medium is not a transitory signal per se, the program instructions executable by a computer to cause the computer to perform a method, comprising:
detecting and saving a communication history for each of a plurality of contacts on a mobile device;
analyzing the communication history for a contact of the plurality of contacts on the mobile device, in response to a user initiating communication with the contact;
detecting one or more communication techniques for communicating with the contact as part of the communication history;
determining a communication protocol for the contact, the communication protocol including one or more of the communication techniques for communicating with the contact; and
iteratively initiating communication to the contact based on the communication protocol using the communication techniques.
